(19) United States
(12) Patent Application Publication
(10) Pub. No.: US 2018/0150154 A1
(43) Pub. Date: May 31, 2018

(54) ELECTROCONDUCTIVE FILM AND METHOD FOR PRODUCING SAME

(71) Applicant: ZEON CORPORATION, Chiyoda-ku, Tokyo (JP)

(72) Inventor: Hiroshi YAKABE, Tokyo (JP)

(73) Assignee: ZEON CORPORATION, Chiyoda-ku, Tokyo (JP)

(21) Appl. No.: 15/573,794

(22) PCT Filed: May 27, 2016
(86) PCT No.: PCT/JP2016/065704

§ 371 Date: Nov. 13, 2017

(30) Foreign Application Priority Data
May 28, 2015 (JP) 2015-108198

(51) Int. Cl. G06F 3/044; B32B 7/02; B32B 15/20

(52) U.S. Cl. CPC G06F 3/044; B32B 7/02; B32B 15/20; G06F 2203/04111; B32B 2307/202; B32B 2307/538; B32B 2457/208

(57) ABSTRACT

An electroconductive film for a touch panel including a substrate film formed of an alicyclic olefin resin and an electroconductive layer provided on a surface of the substrate film, wherein: the electroconductive layer includes a plurality of electrode portions provided in a shape of lines in an input region of the surface of the substrate film; a width of each of the electrode portions is 500 nm or more; and a thickness of each of the electrode portions is 500 nm or more.

### FIELD

The present invention relates to an electroconductive film for a touch panel and a method for producing the same.

### BACKGROUND

In recent years, image display devices such as a liquid crystal display device and an organic electroluminescent display device (hereinafter, also appropriately referred to as an “organic EL display device”) often include a touch panel as an input device on a screen of the image display device. Such a touch panel is usually provided to allow a user to input information by touching a specified position while referring to an image displayed on the screen of the image display device as needed.

The touch panel described above usually includes an electroconductive film having a transparent substrate and an electroconductive layer formed on the substrate. As the substrate of the electroconductive film, a glass substrate has been widely used, however, a resin film is currently taken into consideration (Patent Literature 1).

### CITATION LIST

### Patent Literature

Patent Literature 1: Japanese Patent Application Laid-Open No. 2014-112510 A

### SUMMARY

### Technical Problem

However, attempts of applying the prior-art electroconductive film having the resin film as the substrate to a large-area touch panel have been resulted in insufficient detection sensitivity for detecting a touch of a user. Thus it has been difficult to apply such an electroconductive film to a large-area touch panel.

The present invention has been made in view of the above-mentioned problem, and an object of the present invention is to provide an electroconductive film applicable to a large-area touch panel and a method for producing the same.

### Solution to Problem

The present inventor conducted earnest studies to solve the above-mentioned problem and found that an electroconductive film applicable to a large-area touch panel can be realized by providing an electrode portion of a specific size on a substrate film formed of an alicyclic olefin resin. Based on this finding, the present invention has been completed.

Specifically, the present invention provides the following.

(1) An electroconductive film for a touch panel comprising a substrate film formed of an alicyclic olefin resin and an electroconductive layer provided on a surface of the substrate film, wherein:

the electroconductive layer includes a plurality of electrode portions provided in a shape of lines in an input region of the surface of the substrate film;

a width of each of the electrode portions is 500 nm or more; and

a thickness of each of the electrode portions is 500 nm or more.

(2) The electroconductive film according to (1), wherein the electrode portions include a plurality of first electrode portions extending in one direction and a plurality of second electrode portions extending in one direction crossing to the direction in which the first electrode portions extend.

(3) The electroconductive film according to (1) or (2), wherein an arithmetic surface roughness of the surface of the substrate film is 10 μm or less.

(4) The electroconductive film according to any one of (1) to (3), wherein the electroconductive layer is formed of copper.

(5) The electroconductive film according to any one of (1) to (4), wherein an area of the input region on the surface of the substrate film is 2,700 cm² or more.

### Advantageous Effects of Invention

According to the present invention, there can be provided an electroconductive film applicable to a large-area touch panel and a method for producing the same.

### BRIEF DESCRIPTION OF DRAWINGS

FIG. 1 is a plan view schematically illustrating an electroconductive film for a touch panel according to a first embodiment of the present invention, viewed from a thickness direction.

FIG. 2 is a plan view schematically illustrating an electroconductive film for a touch panel according to a second embodiment of the present invention, viewed from a thickness direction.

FIG. 3 is a plan view schematically illustrating another electroconductive film for a touch panel according to the second embodiment of the present invention, viewed from a thickness direction.

FIG. 4 is a plan view schematically illustrating a composite electroconductive film for a touch panel according to the second embodiment of the present invention, viewed from a thickness direction.

### DESCRIPTION OF EMBODIMENTS

The present invention will be described in detail below by way of embodiments and examples. However, the present invention is not limited to the following embodiments and examples and may be implemented with any modifications without departing from the scope of the claims and equivalents thereto.

In the following description, a “long-length” film means a film having a length of at least five times or more a film width, preferably a length of ten times or more, and specifically means a film of an extent of length enough to be wound in a roll shape for storage or transportation.

In the following description, an in-plane retardation Re of a film is a value represented by Re=(nx−ny)×d, unless otherwise specified. In the formula, nx represents a refractive index in a direction in which the maximum refractive index is given among directions perpendicular to a thickness direction of the film (in-plane directions), ny represents a refractive index in a direction, among the above-mentioned in-plane directions, orthogonal to the direction giving nx, and d represents a thickness of the film. A measurement wavelength is 550 nm unless otherwise specified.

In the following description, a direction of an element being “parallel” and “perpendicular” may allow errors within the bound of not impairing the effect of the present invention, for example, within a range of ±5°, unless otherwise specified.

In the following description, a “wavelength plate” and a “polarizing plate” may include not only a rigid member, but also a flexible member, such as, for example, a resin film, unless otherwise specified.

### 1. First Embodiment

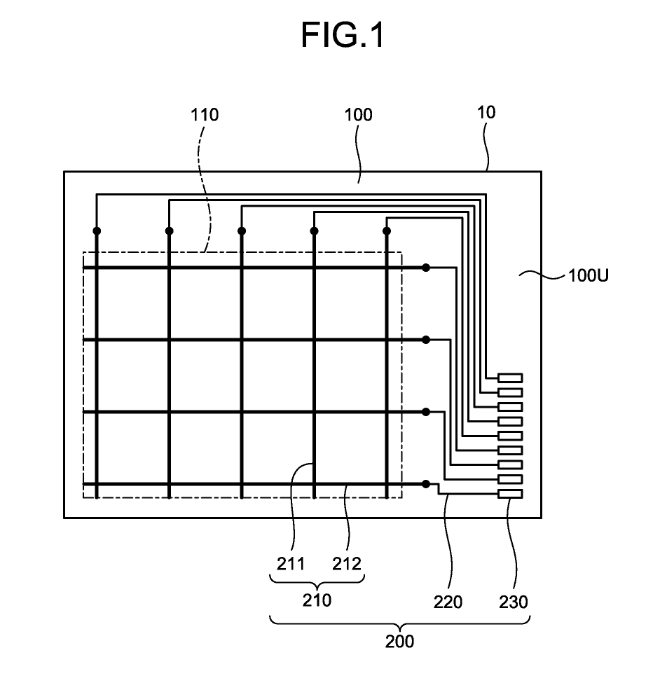

FIG. 1 is a plan view schematically illustrating an electroconductive film 10 for a touch panel according to a first embodiment of the present invention, viewed from a thickness direction.

As shown in FIG. 1, the electroconductive film 10 for a touch panel according to the first embodiment of the present invention includes a substrate film 100 formed of an alicyclic olefin resin and an electroconductive layer 200 provided on a surface 100U of the substrate film 100. The electroconductive film 10 shown in FIG. 1 is an electroconductive film for an electrostatic capacitance type touch panel, and the electroconductive layer 200 thereof includes a plurality of electrode portions 210 disposed in a shape of lines, wiring portions 220 connected to the electrode portions 210, and terminal portions 230 connected to the wiring portions 220.

The electrode portions 210 include a plurality of first electrode portions 211 extending straight in one direction and a plurality of second electrode portions 212 extending straight in one direction crossing to the direction in which the first electrode portions 211 extend. The first electrode portions 211 and the second electrode portions 212 are provided in a lattice shape when viewed from a thickness direction. In the present embodiment, a description will be given of an example where the direction in which the first electrode portions 211 extend is orthogonal to the direction in which the second electrode portions 212 extend.

The first electrode portions 211 are insulated from the second electrode portions 212 by non-illustrated insulating portions provided at intersection portions between the first electrode portions 211 and the second electrode portions 212. Further, an input region 110 on which a user performs an input operation when using a touch panel is set on the surface 100U of the substrate film 100. The electrode portions 210 of the electroconductive layer 200 are provided inside the input region 110, and the wiring portions 220 and the terminal portions 230 of the electroconductive layer 200 are provided outside the input region 110.

In the electrostatic capacitance type touch panel including such an electroconductive film 10, when the touch panel is touched by an external conductor (usually a finger), capacitive coupling is generated by the external conductor and the electrode portions 210. The generated capacitive coupling causes a change in capacitance between the electrode portions 210. The change in the capacitance is detected by a driving circuit (not illustrated) connected to the terminal portions 230 to detect a location touched by the external conductor, thereby achieving a function of the touch panel as an input device.

In this configuration, the above-mentioned electrode portions 210 (that is, the first electrode portions 211 and the second electrode portions 212) are usually provided in a shape of fine lines which are hardly visually seen in order to increase transparency of the input region 110. In such a case, a width of each one of the electrode portions 210 is, independently of each other, usually 500 nm or more, preferably 2,000 nm or more, and further preferably 3,000 nm or more, and is preferably 7 or less, further preferably 6 μm or less, and particularly preferably 5 μm or less. Further, a thickness of the electrode portions 210 is, independently of each other, usually 500 nm or more, and is preferably 20 μm or less, further preferably 10 μm or less, and particularly preferably 5 μm or less. When the width and the thickness of the electrode portions 210 are less than 500 nm, resistance increases so that the touch panel may not function.

The above-mentioned electroconductive film 10, which is prepared by combining the electrode portions 210 of the specific size with the substrate film 100 formed of the alicyclic olefin resin, has an increased detection sensitivity for detecting the touch of the external conductor to the touch panel. Thus, using the electroconductive film 10 makes it possible to enlarge an area of the touch panel. Although it is not exactly clear why the detection sensitivity is increased, the present inventor speculates as follows. Note that the technical scope of the present invention is not limited by the following speculation.

A dielectric constant of the alicyclic olefin resin forming the substrate film 100 is generally as low as about 2.3. The substrate film 100 with such a low dielectric constant can reduce a transmission loss, thus making it possible to facilitate the detection of the capacitance change between the first electrode portions 211 and the second electrode portions 212 of the electroconductive layer 200 when the electrostatic capacitance type touch panel is used. Further, when the width and the thickness of the first electrode portions 211 and the second electrode portions 212 are confined to the specific ranges as described above, their resistances can be reduced, thereby further reducing the transmission loss to further increase the detection sensitivity for the capacitance change. Thus, the touch panel including the above-mentioned electroconductive film 10 can detect the capacitance change with the high detection sensitivity even if the surface area is large. As a result, the large-area touch panel capable of stably detecting the touch of the external conductor can be realized.

An area of the input region 110 is preferably large from the viewpoint of effectively utilizing the above-mentioned advantage allowing a larger surface area. The specific area of the above-mentioned input region 110 is preferably 2,700 cm² or more.

### 2. Second Embodiment

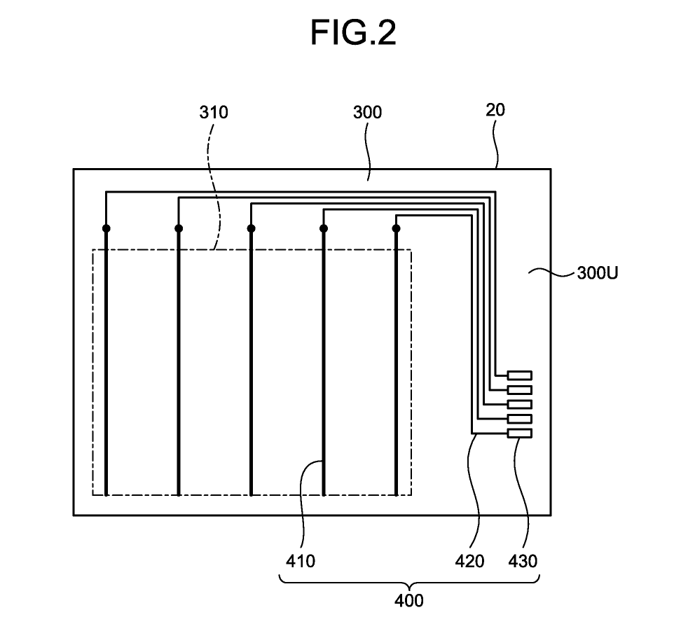

FIG. 2 is a plan view schematically illustrating an electroconductive film 20 for a touch panel according to a second embodiment of the present invention, viewed from a thickness direction.

As shown in FIG. 2, the electroconductive film 20 for a touch panel according to the second embodiment of the present invention includes a substrate film 300 formed of an alicyclic olefin resin and an electroconductive layer 400 provided on a surface 300U of the substrate film 300. Further, the electroconductive layer 400 includes electrode portions 410 provided in a shape of lines, wiring portions 420 connected to the electrode portions 410, and terminal portions 430 connected to the wiring portions 420.

A plurality of the electrode portions 410 are provided so as to extend straight in one direction. In the present embodiment, a description will be given of an example where the electrode portions 410 extend in a vertical direction in the drawings. Further, an input region 310 on which a user performs an input operation when using a touch panel is set on the surface 300U of the substrate film 300. The electrode portions 410 of the electroconductive layer 400 are provided inside the input region 310, and the wiring portions 420 and the terminal portions 430 of the electroconductive layer 400 are provided outside the input region 310.

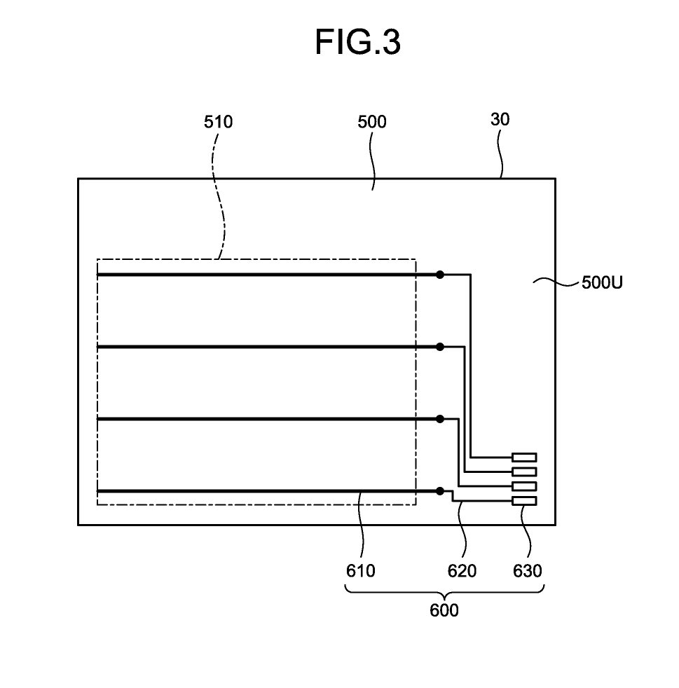

FIG. 3 is a plan view schematically illustrating another electroconductive film 30 for a touch panel according to the second embodiment of the present invention, viewed from a thickness direction.

As shown in FIG. 3, the electroconductive film 30 for a touch panel according to the second embodiment of the present invention includes a substrate film 500 formed of an alicyclic olefin resin and an electroconductive layer 600 provided on a surface 500U of the substrate film 500. Further, the electroconductive layer 600 includes electrode portions 610 provided in a shape of lines, wiring portions 620 connected to the electrode portions 610, and terminal portions 630 connected to the wiring portions 620.

A plurality of the electrode portions 610 are provided so as to extend straight in one direction. In the present embodiment, a description will be given of an example where the electrode portions 610 extend in a horizontal direction in the drawings. Further, an input region 510 on which a user performs an input operation when using a touch panel is set on the surface 500U of the substrate film 500. The electrode portions 610 of the electroconductive layer 600 are provided inside the input region 510, and the wiring portions 620 and the terminal portions 630 of the electroconductive layer 600 are provided outside the input region 510.

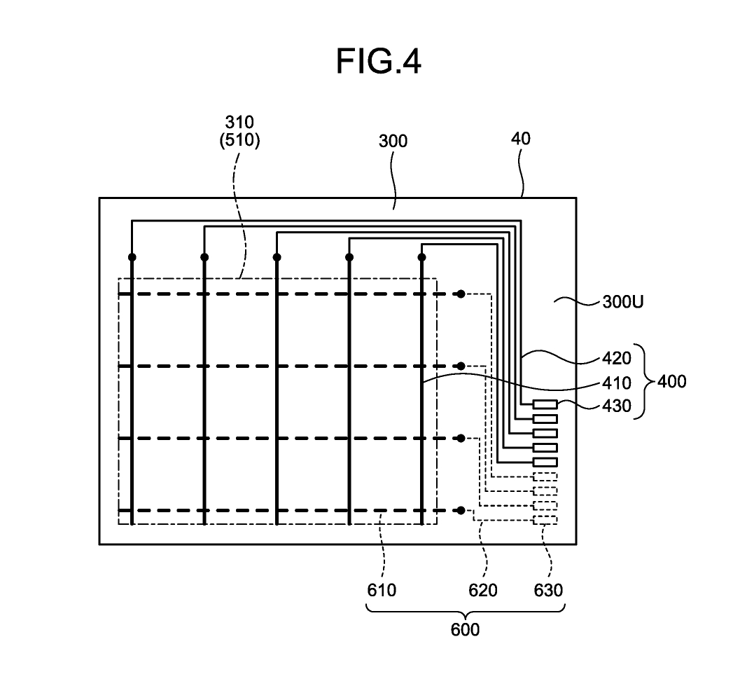

FIG. 4 is a plan view schematically illustrating a composite electroconductive film 40 for a touch panel according to the second embodiment of the present invention, viewed from a thickness direction.

When the electroconductive films 20 and 30 described above are provided to the electrostatic capacitance type touch panel, they are attached to each other as shown in FIG. 4 to be used as the composite electroconductive film 40. The composite electroconductive film 40 is a multilayer film including the electroconductive film 20 and the electroconductive film 30. In the composite electroconductive film 40, the direction in which the electrode portions 410 of the one electroconductive film 20 extend intersects the direction in which the electrode portions 610 of the other electroconductive film 30 extend. As a result, the electrode portions 410 and the electrode portions 610 form a lattice shape when viewed from the thickness direction. Further, the electrode portions 410 are insulated from the electrode portions 610 by the substrate film 300 or 500, or any insulation layer (not illustrated) interposed therebetween.

In the electrostatic capacitance type touch panel including such a composite electroconductive film 40, when the touch panel is touched by the external conductor, the capacitive coupling is generated by the external conductor and the electrode portions 410 and 610. Then, a location touched by the external conductor is detected in the same manner as in the electroconductive film 10 according to the first embodiment to achieve the function of the touch panel as an input device.

Further, in the present embodiment, as is the case for the first embodiment, when the width and the thickness of each one of the electrode portions 410 and 610 are confined within the specific ranges as described in the first embodiment, the detection sensitivity for detecting the touch of the external conductor to the touch panel can be increased. Thus, using the composite electroconductive film 40 makes it possible to enlarge an area of the touch panel. As is the case for the first embodiment, the areas of the input regions 310 and 510 are preferably large from the viewpoint of effectively utilizing the advantage allowing a larger surface area.

### 3. Modification

The electroconductive film is not limited to the embodiments described above and may be implemented with any modifications.

For example, the shape of the electrode portions may be further modified from the embodiments described above.

Further, in the embodiments described above, the electroconductive layer is formed on only one side of the substrate film in each case, and however, the electroconductive layer may be formed on both sides of the substrate film. For example, in the electroconductive film according to the first embodiment, the first electrode portions 211 may be provided on one surface of the substrate film 100 and the second electrode portions 212 may be provided on the other surface of the substrate film 100. In this case, the first electrode portions 211 are insulated from the second electrode portions 212 by the substrate film 100.

Further, the electroconductive film may further include an optional layer in combination with the substrate film and the electroconductive layer. For example, the electroconductive film may include a protective layer for protecting the electroconductive layer, an adhesive layer for effecting adhesion of the electroconductive film to an optional member, and the like.

### 4. Substrate Film

The substrate film is formed of an alicyclic olefin resin. The alicyclic olefin resin is a resin containing an alicyclic olefin polymer. Further, the alicyclic olefin polymer is a polymer having an alicyclic structure as a structural unit of the polymer. Such an alicyclic olefin resin is usually excellent in heat resistance, moisture resistance, and transparency.

Examples of the alicyclic olefin polymer may include a polymer having an alicyclic structure in a main chain, a polymer having an alicyclic structure in a side chain, a polymer having an alicyclic structure in a main chain and a side chain, and a mixture of two or more thereof at any ratio. Of these, a polymer having an alicyclic structure in a main chain is preferable from the viewpoint of mechanical strength and heat resistance.

Examples of the alicyclic structure may include a saturated alicyclic hydrocarbon (cycloalkane) structure and an unsaturated alicyclic hydrocarbon (cycloalkene and cycloalkyne) structure. Of these, a cycloalkane structure and a cycloalkene structure are preferable from the viewpoint of mechanical strength and heat resistance. Of these, a cycloalkane structure is particularly preferable.

The number of carbon atoms constituting the alicyclic structure is preferably 4 or more, and more preferably 5 or more, and is preferably 30 or less, more preferably 20 or less, and particularly preferably 15 or less, per alicyclic structure. When the number of carbon atoms constituting the alicyclic structure falls within this range, the substrate film exhibits mechanical strength, heat resistance, and moldability in a highly balanced manner.

A ratio of the structural unit having the alicyclic structure in the alicyclic olefin polymer is preferably 55% by weight or more, further preferably 70% by weight or more, and particularly preferably 90% by weight or more. When the ratio of the structural unit having the alicyclic structure in the alicyclic olefin polymer falls within this range, the substrate film becomes excellent in transparency and heat resistance.

Preferable examples of the alicyclic olefin polymer may include a norbornene-based polymer, a cyclic olefin polymer having a monocyclic structure, a cyclic conjugated diene polymer, a vinyl alicyclic hydrocarbon polymer, and hydrogenated products thereof. Of these, a norbornene-based polymer is particularly preferable because of its excellent transparency and moldability.

Examples of the norbornene-based polymer may include: a ring-opening polymer of a norbornene structure-containing monomer and a hydrogenated product thereof; and an addition polymer of a norbornene structure-containing monomer and a hydrogenated product thereof. Further, examples of the ring-opening polymer of the norbornene structure-containing monomer may include a ring-opening homopolymer of one type of norbornene structure-containing monomer, a ring-opening copolymer of two or more types of norbornene structure-containing monomer, and a ring-opening copolymer of a norbornene structure-containing monomer and an optional monomer copolymerizable therewith. Further, examples of the addition polymer of the norbornene structure-containing monomer may include an addition homopolymer of one type of norbornene structure-containing monomer, an addition copolymer of two or more types of norbornene structure-containing monomer, and an addition copolymer of a norbornene structure-containing monomer and an optional monomer copolymerizable therewith. Examples of these polymers may include those disclosed in Japanese Patent Application Laid-Open No. 2002-321302 A. Of these, the hydrogenated ring-opening polymer of a norbornene structure-containing monomer is particularly preferable from the viewpoint of transparency, moldability, heat resistance, low hygroscopicity, size stability, lightweight property, and the like.

Examples of the norbornene structure-containing monomer may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]deca-3-ene (common name: methanotetrahydrofluorene), tetracyclo[4.4.0.1^{2,5}.1^{7,10}]dodeca-3-ene (common name: tetracyclododecene), and derivatives of these compounds (for example, those having a substituent in the ring structure). Examples of the substituent herein may include an alkyl group, an alkylene group, and a polar group. Further, a plurality of such substituents may be bonded to the ring whether they may be the same as or different from each other. As the norbornene structure-containing monomer, one type thereof may be solely used, and two or more types thereof may also be used in combination at any ratio.

Examples of the polar group may include a hetero atom and an atomic group containing a hetero atom. Examples of the hetero atom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, an amido group, an imido group, a nitrile group, and a sulfonic acid group.

Examples of the monomer that is ring-opening copolymerizable with the norbornene structure-containing monomer may include: monocyclic olefins such as cyclohexene, cycloheptene, and cyclooctene, and derivatives thereof; and cyclic conjugated dienes such as cyclohexadiene and cycloheptadiene, and derivatives thereof. As the monomer that that is ring-opening copolymerizable with the norbornene structure-containing monomer, one type thereof may be solely used, and two or more types thereof may also be used in combination at any ratio.

The ring-opening polymer of the norbornene structure-containing monomer may be produced, for example, by polymerizing or copolymerizing such a monomer in the presence of a ring-opening polymerization catalyst.

Examples of the monomer that is addition-copolymerizable with the norbornene structure-containing monomer may include: α-olefins of 2 to 20 carbon atoms, such as ethylene, propylene, and 1-butene, and derivatives thereof; cycloolefins, such as cyclobutene, cyclopentene, and cyclohexene, and derivatives thereof; and non-conjugated dienes, such as 1,4-hexadiene, 4-methyl-1,4-hexadiene, and 5-methyl-1,4-hexadiene. Of these, the α-olefins are preferable, and ethylene is more preferable. Further, as the monomer that is addition-copolymerizable with the norbornene structure-containing monomer, one type thereof may be solely used, and two or more types thereof may also be used in combination at any ratio.

The addition polymer of the norbornene structure-containing monomer may be produced, for example, by polymerizing or copolymerizing such a monomer in the presence of an addition polymerization catalyst.

The hydrogenated ring-opening polymer and the hydrogenated addition polymer described above may be produced, for example, by hydrogenating carbon-carbon unsaturated bonds preferably by 90% or more in a solution of any of the ring-opening polymer and the addition polymer in the presence of a hydrogenation catalyst containing a transition metal such as nickel and palladium.

Among the norbornene-based polymers, it is preferable that the polymer has an X: bicyclo [3.3.0] octane-2,4-diyl-ethylene structure and a Y: tricyclo [4.3.0.1^{2,5}] decane-7,9-diyl-ethylene structure as structural units, and that the content of these structural units is 90% by weight or more with respect to the entire structural unit content of the norbornene-based polymer, and a weight ratio of X and Y as X:Y is 100:0 to 40:60. By using such a polymer, the substrate film can exhibit excellent stability in optical characteristics without having a size change over a long period of time.

As the alicyclic olefin polymer, one type thereof may be solely used, and two or more types thereof may also be used in combination at any ratio.

The weight-average molecular weight (Mw) of the alicyclic olefin polymer is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight of the alicyclic olefin polymer falls within such a range, the substrate film exhibits mechanical strength and molding workability in a highly balanced manner, and thus such a configuration is preferable. Herein, the above-mentioned weight-average molecular weight is a polyisoprene or polystyrene equivalent weight-average molecular weight measured by gel permeation chromatography using cyclohexane as a solvent. Further, if a sample is insoluble in cyclohexane, toluene may be used as a solvent in the above-mentioned gel permeation chromatography.

The molecular weight distribution (weight-average molecular weight (Mw)/number-average molecular weight (Mn)) of the alicyclic olefin polymer is preferably 1 or more, and more preferably 1.2 or more, and is preferably 10 or less, more preferably 4 or less, and particularly preferably 3.5 or less.

The ratio of the alicyclic olefin polymers in the alicyclic olefin resin is preferably 50% by weight to 100% by weight, more preferably 70% by weight to 100% by weight, and particularly preferably 90% by weight to 100% by weight. When the ratio of the alicyclic olefin polymers falls within the above-mentioned range, the substrate film exhibits sufficient heat resistance and transparency.

The alicyclic olefin resin may include an additive in addition to the alicyclic olefin polymer. Examples of the additive may include an antioxidant, a heat stabilizer, a light stabilizer, an ultraviolet absorber, an antistatic agent, a dispersant, a chlorine-capturing agent, a flame retardant, a nucleating agent for crystallization, a reinforcing agent, an anti-blocking agent, an anti-fogging agent, a release agent, a pigment, an organic or inorganic filler, a neutralizer, a lubricant, a decomposing agent, a metal-inactivating agent, a contamination inhibitor, an antibacterial agent, an optional polymer, and a thermoplastic elastomer. One type thereof may be solely used, and two or more types thereof may also be used in combination at any ratio.

The glass transition temperature Tg of the alicyclic olefin resin is preferably 120° C. or higher, more preferably 125° C. or higher, and particularly preferably 130° C. or higher, and is preferably 180° C. or lower, more preferably 175° C. or lower, and particularly preferably 165° C. or lower. With the glass transition temperature at the lower limit value or higher of the above-mentioned range, the alicyclic olefin resin can give to the substrate film an enhanced durability in a high temperature environment. With the glass transition temperature at the upper limit value or lower, production of the substrate film can be easily performed.

The total light transmittance of the substrate film is preferably 80% or more, and more preferably 90% or more. The light transmittance may be measured using a spectrophotometer (ultraviolet-visible-near-infrared spectrophotometer “V-570” manufactured by JASCO Corp.) in accordance with JIS K0115.

The haze of the substrate film is preferably 5% or less, more preferably 3% or less, particularly preferably 1% or less, and ideally 0%. The haze described herein may be an average of the measured values of five points that are measured using a “turbidity meter NDH-300A” manufactured by Nippon Denshoku Industries Co., Ltd. in accordance with JIS K7361-1997.

The substrate film may be an optically isotropic film having no in-plane retardation Re or an optically anisotropic film having an in-plane retardation Re. When the substrate film has optical anisotropy, the in-plane retardation Re of the substrate film is preferably 80 nm or more, more preferably 100 nm or more, and particularly preferably 120 nm or more, and is preferably 180 nm or less, more preferably 160 nm or less, and particularly preferably 150 nm or less. The substrate film having the in-plane retardation Re in the above-mentioned range can function as a ¼ wavelength plate. Thus, such a substrate film can convert linearly polarized light passing through the substrate film into circularly polarized light. As such, a circular polarizing plate may be produced by combining the electroconductive film with a linear polarizer. This circular polarizing plate can function as an antireflection film in an image display device.

The moisture vapor permeability of the substrate film is preferably 1 g/(m²·day) or less, more preferably 0.5 g/(m²·day) or less, and particularly preferably 0.2 g/(m²·day) or less. The lower limit of the moisture vapor permeability is particularly preferably 0 g/(m²·day). The substrate film having such a low moisture vapor permeability can enhance moisture vapor barrier properties by the substrate film. Further, this can reduce a change in electrical characteristics of the image display device. The moisture vapor permeability of a certain film described herein may be measured using a moisture vapor permeability measuring device (“PERMATRAN-W” manufactured by Mocon Inc.) in accordance with JIS K 7129 B-1992 under conditions of a temperature of 40° C. and a humidity of 90% RH.

The arithmetic surface roughness (also referred to as an “arithmetic average roughness”) Ra on a surface of the substrate film on which the electroconductive layer is formed is preferably 10 μm or less, more preferably 5 μm or less, and particularly preferably 1 μm or less. Reduction of the arithmetic surface roughness Ra on the surface of the substrate film as described above may lead to uniform thickness of the electroconductive layer formed on that surface. This can prevent a locally thin part from being generated on the electroconductive layer, thus making it possible to prevent an increase in resistance in the above-mentioned thin part. As a result, the detection sensitivity for a capacitance change can be enhanced when the touch panel is used. The lower limit of the above-mentioned arithmetic surface roughness Ra is not particularly limited, but it is usually 1 nm or more. The arithmetic surface roughness Ra on the surface of the substrate film may be measured using a non-contact surface profile measuring instrument (for example, NewView series manufactured by Zygo Corp.).

The thickness of the substrate film is preferably 20 μm or more, more preferably 30 μm or more, and particularly preferably 40 μm or more, and is preferably 150 μm or less, more preferably 130 μm or less, and particularly preferably 100 μm or less. With the thickness of the substrate film at the lower limit value or higher of the above-mentioned range, mechanical strength of the substrate film can be sufficiently enhanced. With the thickness at the upper limit value or lower of the above-mentioned range, the thickness of the substrate film can be reduced.

The substrate film may be produced, for example, by a production method including a step of molding the alicyclic olefin resin into a film shape. Examples of the method for molding the alicyclic olefin resin may include a melt molding method and a solution casting method. Examples of the melt molding method may include a melt extrusion method in which molding is performed by melt extrusion, a press molding method, an inflation molding method, an injection molding method, a blow molding method, and a stretch molding method. Of these, the melt extrusion method, the inflation molding method, and the press molding method are preferable from the viewpoint of obtaining the substrate film excellent in mechanical strength and surface precision. Of these, in particular, the melt extrusion method is particularly preferable as it can reduce an amount of a residual solvent and allows an efficient and simple production. Further, in particular, the substrate film produced by the melt extrusion method can reduce outgas from the substrate film when a film formation method, such as a sputtering method, is performed to form the electroconductive layer, thus allowing the excellent film formation of the electroconductive layer. Example of the preferable molding method may include those disclosed in Japanese Patent Application Laid-Open Nos. Hei. 3-223328 A, 2000-280315 A, and the like.

In the melt extrusion method, usually, the alicyclic olefin resin is melted and the molten resin is extruded from a die to perform molding in a film shape. In this process, the melting temperature of the alicyclic olefin resin in an extruder equipped with the die is preferably Tg+80° C. or higher, and more preferably Tg+100° C. or higher, and is preferably Tg+180° C. or lower, and more preferably Tg+150° C. or lower. Tg herein represents a glass transition temperature of the alicyclic olefin resin. By keeping the melting temperature of the alicyclic olefin resin in the extruder at the lower limit value or higher of the above-mentioned range, fluidity of the alicyclic olefin resin can be sufficiently increased. By keeping the melting temperature at the upper limit value or lower, deterioration of the alicyclic olefin resin can be prevented.

The molten resin extruded from the die in a film shape is usually brought into close contact with a cooling roll. The method for bringing the molten resin into close contact with the cooling roll is not particularly limited, and examples of such a method include an air knife method, a vacuum box method, and an electrostatic adhesion method.

The number of the cooling rolls is not particularly limited, but it is usually two or more. Further, the mode of disposing the cooling rolls is not particularly limited, but, for example, the disposing may be of a linear type, a Z type, an L type, or the like. Further, no particular limitation is imposed on a manner of passing the molten resin extruded from the die through the cooling rolls.

The degree of close contact between the resin extruded in a film shape and the cooling roll usually tends to change depending on a temperature of the cooling roll. The contact becomes tight by increasing the temperature of the cooling roll. However, if the temperature is too high, there occurs a tendency that the resin in a film shape is unremovable from the cooling roll. Thus, the temperature of the cooling roll is preferably Tg+30° C. or lower, and further preferably Tg−5° C. or lower, and is preferably Tg−45° C. or higher.

By molding the alicyclic olefin resin into a film shape as described above, the substrate film formed of the alicyclic olefin resin may be obtained. The substrate film is usually obtained as a long-length film. Further, the substrate film may be an unstretched film without being subjected to a stretching treatment. Alternatively, the substrate film may be a stretched film that has been subjected to a stretching treatment. The stretching treatment allows the substrate film to develop a desired in-plane retardation.

The stretching treatment may be performed by a uniaxial stretching treatment in which stretching is performed in one direction or a biaxial stretching treatment in which stretching is performed in two different directions. Further, the biaxial stretching treatment may be performed by a simultaneous biaxial stretching treatment in which stretching is performed in two directions at the same time or a sequential biaxial stretching treatment in which stretching is first performed in one direction and then in another direction. Further, the stretching may be performed by any one of the followings: a longitudinal stretching treatment in which the stretching treatment is performed in a lengthwise direction of the substrate film; a transversal stretching treatment in which the stretching treatment is performed in a width direction of the substrate film; a diagonal stretching treatment in which the stretching treatment is performed in a diagonal direction that is neither parallel nor perpendicular to the width direction of the substrate film; or a combination thereof. Examples of the method for performing the stretching treatment may include a roll-type method, a floating-type method, a tenter-type method, and the like.

The stretching temperature and the stretching ratio may be freely set in a range at which the substrate film having a desired in-plane retardation Re can be obtained. As specific examples of these ranges, the stretching temperature is preferably Tg−30° C. or higher, and more preferably Tg−10° C. or higher, and is preferably Tg+60° C. or lower, and more preferably Tg+50° C. or lower. Further, the stretching ratio is preferably 1.1 times or more, more preferably 1.2 times or more, and particularly preferably 1.5 times or more, and is preferably 30 times or less, more preferably 10 times or less, and particularly preferably 5 times or less.

Further, the method for producing the substrate film may further include an optional step in addition to the above-mentioned method. For example, the method for producing the substrate film may include a step of cutting the long-length substrate film into an appropriate shape, such as a rectangular shape.

### 5. Electroconductive Layer

The electroconductive layer is a layer provided on the surface of the substrate film formed of an electroconductive material. The electroconductive layer is usually provided directly on the surface of the substrate film. That the electroconductive layer is provided “directly” on the surface of the substrate film described herein refers to that no layer is interposed between the surface of the substrate film and the electroconductive layer.

Examples of the electroconductive material may include: metal such as silver and copper; and metal oxides such as ITO (indium-tin oxide), IZO (indium-zinc oxide), ZnO (zinc oxide), IWO (indium-tungsten oxide), ITO (indium-titanium oxide), AZO (aluminum-zinc oxide), GZO (gallium-zinc oxide), XZO (a zinc-based special oxide), and IGZO (indium gallium-zinc oxide). As the electroconductive material, one type thereof may be solely used, and two or more types thereof may also be used in combination at any ratio. Of these, metal is preferable because it can be plastically deformable and is less prone to be ruptured by deformation of the substrate film. Especially, copper is more preferable because it is particularly less prone to be ruptured.

The surface resistivity of the electroconductive layer is preferably 1,000 Ω/sq or less, more preferably 500 Ω/sq or less, and particularly preferably 100 Ω/sq or less. The lower limit is not particularly limited, but, for example, it may be 0.1 Ω/sq or more.

The method for forming the electroconductive layer is not limited. For example, as described in Patent Literature 1, the electroconductive layer may be formed by application of a composition containing metal nanowires. Further, for example, the electroconductive layer may be formed on the surface of the substrate film by attaching the electroconductive layer that has been prepared separately from the substrate film to the substrate film. In such an attaching method, use of an unstretched film as the substrate film may reduce occurrence of wrinkles during attaching.

Further, for example, the electroconductive layer may be formed by depositing the electroconductive material on the surface of the substrate film by a film formation method, such as a vapor deposition method, a sputtering method, an ion plating method, an ion beam assisted deposition method, an arc-discharge plasma deposition method, a thermal CVD method, a plasma CVD method, a plating method, and a combination thereof.

Of these, the vapor deposition method and the sputtering method are preferable, and the sputtering method is particularly preferable. The sputtering method allows the formation of the electroconductive layer with uniform thickness and thus can prevent a locally thin part from being generated on the electroconductive layer. This can prevent an increase in resistance in the above-mentioned thin part, thereby making it possible to enhance the detection sensitivity for the capacitance change. Further, many resin films may cause outgas, making it difficult to form the electroconductive layer by sputtering. In contrast, the substrate film formed of the alicyclic olefin resin is less prone to cause outgas. Further, the substrate film formed of the alicyclic olefin resin has high mechanical strength and is thus less prone to cause rupture in an environment where the sputtering is performed. Thus, one of the advantages of using the substrate film formed of the alicyclic olefin resin is that the electroconductive layer can be formed by the sputtering method as described above.

Further, a surface treatment may be performed on the surface of the substrate film before the electroconductive layer is formed on that surface of the substrate film. Examples of the surface treatment may include a corona treatment, a plasma treatment, and a chemical treatment. The surface treatment can improve binding properties between the substrate film and the electroconductive layer.

Further, the method for forming the electroconductive layer may include a step of forming the electroconductive layer in a desired pattern shape, for example, by a film removal method, such as an etching method. The substrate film formed of the alicyclic olefin resin usually has high alkali resistance. Therefore, when the electroconductive material such as copper is etched by an alkali solution, the substrate film is less prone to be corroded by the alkali solution, thus the width and the thickness of the electrode portions are less prone to be distorted. Further, using the substrate film having high alkali resistance makes it possible to increase an alkali concentration in the alkali solution to accelerate the etching speed.

### 6. Properties of Electroconductive Film

The electroconductive film preferably has high total light transmittance in the input region from the viewpoint of improving visibility of an image display device in which the touch panel is installed. The specific total light transmittance in the input region of the electroconductive film is preferably 80% or more, more preferably 85% or more, and particularly preferably 90% or more. The total light transmittance may be measured in a wavelength range of 400 nm to 700 nm using an ultraviolet-visible spectroscopy.

### 7. Use of Electroconductive Film

The electroconductive film described above may be installed in a touch panel to be used. Such a touch panel may be installed and used, for example, in a screen of an image display device, such as a liquid crystal display device and an organic EL display device.

### EXAMPLES

The present invention will be described in detail below by way of Examples. However, the present invention is not limited to the following Examples and may be implemented with any modifications without departing from the scope of the claims of the present invention and equivalents thereto. Unless otherwise specified, operations described below were performed in an atmospheric air of an ordinary-temperature and ordinary-pressure.

[Evaluation Methods]

(Method for Evaluating Transmittance)

The total light transmittance of the obtained electroconductive film was measured at five points in the input region using a turbidity meter (“NDH-300A” manufactured by Nippon Denshoku Industries Co., Ltd.) in accordance with JIS K7361-1997, and an average value thereof is adopted as the total light transmittance in the input region of the electroconductive film.

(Method for Evaluating Etching Resistance of Substrate Film)

A layer of copper was formed on the substrate film and then the arithmetic surface roughness Ra0 of the surface of the copper layer was measured before an etching treatment was performed. Further, after the etching treatment was performed on the copper layer formed on the surface of the substrate film, the arithmetic surface roughness Ra1 of the surface of the substrate film exposed as a result of the etching treatment was measured. Measurements of the arithmetic surface roughness Ra0 and Ra1 were performed using a non-contact surface profile measuring instrument (“NewView series” manufactured by Zygo Corp.). Small difference between the arithmetic surface roughness Ra0 and the arithmetic surface roughness Ra1 is indicative of excellent etching resistance the substrate film.

### Example 1

(Production of First Electroconductive Film)

As a substrate film, an alicyclic olefin resin film containing a norbornene-based polymer (“ZEONOR ZF16-050” manufactured by ZEON Corporation) was prepared. This substrate film had a thickness of 50 μm, a glass transition temperature of the resin of 160° C., and a dielectric constant of the resin of 2.3.

A corona treatment was performed as a surface treatment on one surface of this substrate film. The arithmetic surface roughness Ra of the surface of the substrate film, on which the corona treatment was performed, was 1.01 nm.

On the surface of the substrate film on which the corona treatment was performed, a copper layer was formed by sputtering. Then, an etching treatment was performed on the formed copper layer to form the copper layer in a desired pattern shape. An electroconductive layer was thus formed. In this manner, as shown in FIG. 2, a first electroconductive film 20, which includes an electroconductive layer 400 having a plurality of electrode portions 410 provided in a shape of straight lines on a surface 300U of a substrate film 300, wiring portions 420 connected to the electrode portions 410, and terminal portions 430 connected to the wiring portions 420, was obtained.

In the first electroconductive film 20, an input region 310 of the substrate film 300 was set in a size of 133.1 cm in a horizontal direction and 74.8 cm in a vertical direction corresponding to an image display device having a screen size of 60 inches. Further, the electrode portions 410 of the electroconductive layer 400 were formed in the input region 310, and the wiring portions 420 and the terminal portions 430 were formed outside the input region 310. Further, the electrode portions 410 were formed so as to extend in the vertical direction, and a width and a thickness of each one of the electrode portions 410 were 5 μm and 700 nm, respectively. Further, the total light transmittance of the input region 310 of the first electroconductive film 20 was 90%. Further, the arithmetic surface roughness Ra0 of the surface of the copper layer before the etching treatment was 1 nm, and the arithmetic surface roughness Ra1 of the surface 300U of the substrate film 300 exposed due to the etching treatment performed to the copper layer was 1.02 nm.

(Production of Second Electroconductive Film)

Further, as shown in FIG. 3, a second electroconductive film 30, which includes an electroconductive layer 600 having a plurality of electrode portions 610 provided in a shape of straight lines on a surface 500U of a substrate film 500, wiring portions 620 connected to the electrode portions 610, and terminal portions 630 connected to the wiring portions 620, was produced in the same manner as the above-mentioned first electroconductive film 20 except that a pattern shape of the electroconductive layer was changed.

In the second electroconductive film 30, an input region 510 of the substrate film 500 was set in a size of 133.1 cm in a horizontal direction and 74.8 cm in a vertical direction as is the case for the first electroconductive film 20. Further, the electrode portions 610 of the electroconductive layer 600 were formed in the above-mentioned input region 510, and the wiring portions 620 and the terminal portions 630 were formed outside the input region 510. Further, the electrode portions 610 were formed so as to extend in the horizontal direction, and a width and a thickness of each one of the electrode portions 610 were 5 μm and 700 nm, respectively. Further, the total light transmittance of the input region 510 of the second electroconductive film 30 was 90%. Further, the arithmetic surface roughness Ra0 of a surface of a copper layer before the etching treatment was 1 nm, and the arithmetic surface roughness Ra1 of the surface 500U of the substrate film 500 exposed due to the etching treatment performed to the copper layer was 1.02 nm.

(Production of Composite Electroconductive Film)

A glass substrate (“Gorilla Glass” manufactured by Corning Inc., thickness 0.7 mm) was attached to the second electroconductive film 30 on the side of the substrate film 500 via an optical adhesive sheet (“TD06A” manufactured by Tomoegawa Co., Ltd., thickness 25 μm). Subsequently, the second electroconductive film 30 on the side of the electroconductive layer 600 was attached to the first electroconductive film 20 on the side of the electroconductive layer 400 via the optical adhesive sheet (“TD06A” manufactured by Tomoegawa Co., Ltd., a thickness of 25 μm). In this manner, a composite electroconductive film including (the glass substrate)/(the optical adhesive sheet)/(the substrate film 500 of the second electroconductive film 30)/(the electroconductive layer 600 of the second electroconductive film 30)/(the optical adhesive sheet)/(the electroconductive layer 400 of the first electroconductive film 20)/(the substrate film 300 of the first electroconductive film 20) in this order was obtained. In this composite electroconductive film, the electrode portions 410 of the first electroconductive film 20 and the electrode portions 610 of the second electroconductive film 30 are orthogonal to each other to form a lattice shape as a whole when viewed from the thickness direction, as shown in FIG. 4.

The terminal portions of the above-mentioned composite electroconductive film were connected to a driving circuit to assemble a touch panel. Then, a center portion of the input region on the substrate film of the first electroconductive film was touched by a finger 100 times to measure the number of successful detections of the finger contact. As a result of the measurement, the touch panel produced in Example 1 was able to detect 100 finger contacts.

### Example 2

Electroconductive films and a touch panel were produced and evaluated in the same manner as in Example 1 except that the width of each one of the electrode portions 410 and 610 was set to 3 μm and the thickness of each of the electrode portions 410 and 610 was set to 500 nm.

The total light transmittances of the input regions of the first electroconductive film and the second electroconductive film were 91%. Further, the arithmetic surface roughness Ra0 of the surface of the copper layer before the etching treatment was 1.00 nm, and the arithmetic surface roughness Ra1 of the surface of the substrate film exposed due to the etching treatment performed to the copper layer was 1.01 nm.

Further, as a result of measurement of the touch panel, the touch panel produced in Example 2 was able to detect 100 finger contacts among the 100 finger contacts.

### Example 3

Electroconductive films and a touch panel were produced and evaluated in the same manner as in Example 1 except that the thickness of the electrode portions 410 and 610 was set to 500 nm.

The total light transmittances of the input regions of the first electroconductive film and the second electroconductive film were 90%. Further, the arithmetic surface roughness Ra0 of the surface of the copper layer before the etching treatment was 1.10 nm, and the arithmetic surface roughness Ra1 of the surface of the substrate film exposed due to the etching treatment performed to the copper layer was 1.05 nm.

Further, as a result of measurement of the touch panel, the touch panel produced in Example 3 was able to detect 100 finger contacts among the 100 finger contacts.

### Comparative Example 1

Electroconductive films and a touch panel were produced and evaluated in the same manner as in Example 1 except that a polyethylene terephthalate resin film (“A4100” manufactured by Toyobo Co., Ltd.) was used as the substrate film. This substrate film had a thickness of 50 μm, an arithmetic surface roughness Ra of its surface of 11.47 mm, and a dielectric constant of the resin of 3.2.

The total light transmittances of the input regions of the first electroconductive film and the second electroconductive film were 79%. Further, the arithmetic surface roughness Ra0 of the surface of the copper layer before the etching treatment was 12.89 nm, and the arithmetic surface roughness Ra1 of the surface of the substrate film exposed due to the etching treatment performed to the copper layer was 135 nm.

Further, as a result of measurement of the touch panel, the touch panel produced in Comparative Example 1 was able to detect only 88 finger contacts among the 100 finger contacts.

### Comparative Example 2

Electroconductive films and a touch panel were produced and evaluated in the same manner as in Example 1 except that the thickness of the electrode portions 410 and 610 was set to 300 nm.

The total light transmittances of the input regions of the first electroconductive film and the second electroconductive film were 90%. Further, the arithmetic surface roughness Ra0 of the surface of the copper layer before the etching treatment was 1 nm, and the arithmetic surface roughness Ra1 of the surface of the substrate film exposed due to the etching treatment performed to the copper layer was 1.06 nm.

Further, as a result of measurement of the touch panel, the touch panel produced in Comparative Example 2 was able to detect only 47 finger contacts among the 100 finger contacts.

### Comparative Example 3

Electroconductive films and a touch panel were produced and evaluated in the same manner as in Example 1 except that the width of each one of the electrode portions 410 and 610 was set to 400 nm.

The total light transmittances of the input regions of the first electroconductive film and the second electroconductive film were 92%. Further, the arithmetic surface roughness Ra0 of the surface of the copper layer before the etching treatment was 1.22 nm, and the arithmetic surface roughness Ra1 of the surface of the substrate film exposed due to the etching treatment performed to the copper layer was 1.12 nm.

Further, as a result of measurement of the touch panel, the touch panel produced in Comparative Example 3 was able to detect only 92 finger contacts among the 100 finger contacts.

### Comparative Example 4

Electroconductive films and a touch panel were produced and evaluated in the same manner as in Comparative Example 1 except that the width of each one of the electrode portions 410 and 610 was set to 15 μm.

The arithmetic surface roughness Ra0 of the surface of the copper layer before the etching treatment was 12.89 nm, and the arithmetic surface roughness Ra1 of the surface of the substrate film exposed due to the etching treatment performed to the copper layer was 135 nm.

Further, as a result of measurement of the touch panel, the touch panel produced in Comparative Example 4 was able to detect 100 finger contacts among the 100 finger contacts.

However, the total light transmittances of the input regions of the first electroconductive film and the second electroconductive film produced in Comparative Example 4 were both 79%, and the product was inferior in transparency for the electroconductive film for the touch panel.

### REFERENCE SIGN LIST

10, 20 and 30 electroconductive film
40 composite electroconductive film
100, 300 and 500 substrate film
110, 310 and 510 input region
200, 400 and 600 electroconductive layer
210, 410 and 610 electrode portion
211 first electrode portion
212 second electrode portion
220, 420 and 620 wiring portion
230, 430 and 630 terminal portion

1. An electroconductive film for a touch panel comprising a substrate film formed of an alicyclic olefin resin and an electroconductive layer provided on a surface of the substrate film, wherein:
the electroconductive layer includes a plurality of electrode portions provided in a shape of lines in an input region of the surface of the substrate film;
a width of each of the electrode portions is 500 nm or more; and
a thickness of each of the electrode portions is 500 nm or more.

2. The electroconductive film according to claim 1, wherein the electrode portions include a plurality of first electrode portions extending in one direction and a plurality of second electrode portions extending in one direction crossing to the direction in which the first electrode portions extend.

3. The electroconductive film according to claim 1, wherein an arithmetic surface roughness of the surface of the substrate film is 10 μm or less.

4. The electroconductive film according to claim 1, wherein the electroconductive layer is formed of copper.

5. The electroconductive film according to claim 1, wherein an area of the input region on the surface of the substrate film is 2,700 cm² or more.
